(19) United States
(12) Patent Application Publication
(10) Pub. No.: US 2007/0087776 A1
(43) Pub. Date: Apr. 19, 2007

(54) Analog front-end circuit

(76) Inventors: Makoto Terada, Ukyo-Ku (JP); Yukinobu Lino, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/524,333

(22) Filed: Sep. 20, 2006

(30) Foreign Application Priority Data
Sep. 20, 2005 (JP) JP2005-272501

(51) Int. Cl. H04B 1/28; H04M 1/00

(52) U.S. Cl. 455/550.1; 455/333

(57) ABSTRACT

An analog front-end circuit transmits and receives data between a baseband circuit and a radio unit. An analog-to-digital converter converts an analog received signal output from the radio unit into a digital signal. An interpolator interpolates an output signal of the analog-to-digital converter by up-sampling the output. A ΣΔ modulator performs a fourth-order ΣΔ modulation on an output signal of the interpolator. A low-voltage differential signal transmitter converts an output signal of the ΣΔ modulator into a low-voltage differential signal and transmits the converted signal to the baseband circuit via differential signal lines.

### BACKGROUND OF THE INVENTION

1. Field of the Invention

The present invention relates to an analog front-end circuit to be provided between a baseband circuit and a radio unit in a radio apparatus.

2. Description of the Related Art

The communication system of mobile phones that is now becoming mainstream is the third generation of CDMA (Code Division Multiple Access) 2000 or W-CDMA (Wideband-CDMA). Compared with the second-generation communication systems, such as GSM (Global System for Mobile communication) or PDC (Personal Digital Cellular), these communication systems can perform communications at extremely high chip rates (or bit rates).

In a third-generation W-CDMA system, for instance, I/Q signals of 10 bits on the transmitting side and 8 bits on the receiving side are transmitted and received at a speed of 10 MHz or above between a digital baseband circuit (hereinafter also referred to simply as a baseband circuit) and an analog radio unit (hereinafter referred to also as RFIC). When a baseband circuit and an RFIC are to be connected with parallel signal lines, it is necessary to connect them using dozens of signal lines. Any increase in the number of signal lines can be a serious problem for mobile phone terminals for which smallness is a requisite.

To solve the problem as described above, there are techniques, as proposed in Reference (1) in the following Related Art List, to reduce the number of signal lines by converting 10-bit or 8-bit signals to signals of higher frequencies through a parallel-serial conversion. Related Art List

(1) Published Japanese Translation of PCT Application No. 2004-519943.

In the technology proposed in Reference (1) in the above Related Art List, however, it is necessary to use a synchronization signal in order to identify each bit string, or the end of each word, when a signal having been parallel-to-serial converted is serial-to-parallel converted. And to accomplish this, signal lines therefore must be added. Instead of the synchronization signal, a preamble needs to be inserted in a bit stream signal.

### SUMMARY OF THE INVENTION

The present invention has been made in view of the foregoing circumstances, and a general purpose thereof is to reduce the number of data signal lines between a baseband circuit and a radio unit in a radio apparatus.

One embodiment of the present invention relates to an analog front-end circuit which transmits and receives data between a baseband circuit and a radio unit. This analog front-end circuit comprises: an analog-to-digital converter which converts an analog received signal output from the radio unit into a digital signal; an interpolator which interpolates an output signal of the analog-to-digital converter by up-sampling the output thereof; a high-order ΣΔ modulator which ΣΔ modulates an output signal of the interpolator; and a low-voltage differential signal transmitter which converts an output signal of the ΣΔ modulator into a low-voltage differential signal and which transmits the converted signal to the baseband circuit via differential signal lines.

According to this embodiment, received signals, composed of in-phase components (hereinafter referred to as I components) and quadrature components (Q components), received by the radio unit are converted respectively into 1-bit digital signals which have been subjected to a high-order ΣΔ modulation, and then transmitted to the baseband circuit. As a result, the number of signal lines can be reduced and the synchronization processing between the analog front-end circuit and the baseband circuit is no longer required.

The analog front-end circuit may further comprise: a low-voltage differential signal receiver which receives, via differential signal lines, a 1-bit transmission signal having been subjected to a high-order ΣΔ modulation and output from the baseband circuit; a decimation circuit which accumulates the 1-bit transmission signal received by the difference signal receiver and performs down-sampling thereon; and a digital-to-analog converter which converts an output signal of the decimation circuit into an analog signal and outputs the converted signal to the radio unit.

According to this embodiment, transmission signals, composed of I components and Q components, generated by the baseband circuit are converted respectively into 1-bit digital signals which have been subjected to a high-order ΣΔ modulation, and then transmitted to the baseband circuit. As a result, the number of signal lines can be reduced and the synchronization processing between the analog front-end circuit and the baseband circuit is no longer required.

The analog front-end circuit may be integrated integrally on a single semiconductor substrate by a CMOS process. Moreover, the semiconductor substrate may be a silicon substrate. The above-described analog front-end circuit is structured by a circuit block that can be easily realized by the use of a normal silicon process, which may comprise an analog-to-digital converter, a digital-to-analog converter, a ΣΔ modulator, an interpolator, and a decimation circuit. Hence, circuit integration is easy and circuit area can be reduced. Moreover, such a circuit block, which can be realized by a silicon process, is of low cost compared with ones made by a silicon-germanium process or the like. “Being integrated integrally” includes a case where all of circuit components are formed on a semiconductor substrate or a case where main circuit components are integrally integrated thereon. Note that part of resistors or capacitors used to adjust circuit constants may be provided externally to the semiconductor substrate.

The interpolator may up-sample by a factor of ten and the order of the ΣΔ modulator may be fourth. In such a case, the modulation accuracy required for a W-CDMA scheme can be maintained.

Another embodiment of the embodiment relates to a baseband circuit connected with a radio unit via an analog front-end circuit. This baseband circuit comprises: a modulator which outputs a transmission signal modulated by a predetermined scheme; an interpolator which performs interpolation by up-sampling the transmission signal output from the modulator; a high-order ΣΔ modulator which ΣΔ modulates an output signal of the interpolator; and a low-voltage differential signal transmitter which converts an output signal of the ΣΔ modulator into a low-voltage differential signal and which transmits the converted signal to the analog front-end circuit via differential signal lines.

According to this embodiment, transmission signals, composed of I components and Q components, generated by the modulator are converted into 1-bit digital signals which have been subjected to a high-order ΣΔ modulation, and then transmitted to the baseband circuit. As a result, the number of signal lines can be reduced and the synchronization processing between the analog front-end circuit and the baseband circuit can be eliminated.

The baseband circuit may further comprise: a low-voltage differential signal receiver which receives, via differential signal lines, a 1-bit received signal having been subjected to a high-order ΣΔ modulation and output from the analog front-end circuit; a decimation circuit which accumulates the 1-bit received signal received by the difference signal receiver and performs down-sampling thereon; and a demodulator which demodulates an output signal of the decimation circuit by a predetermined scheme.

The transmission signals, composed of I components and Q components, received by the radio unit are ΣΔ modulated by the analog front-end circuit, then converted into 1-bit and input to the baseband circuit. This 1-bit received signal is accumulated and down-sampled so as to be restored to a digital signal.

Still another embodiment of the present invention relates to a radio apparatus. This apparatus comprises: a baseband circuit; a radio unit; and an analog front-end circuit which connects the baseband circuit with the radio unit with a low-voltage differential signal. The baseband circuit up-samples and interpolates a transmission signal to be output to the radio unit, then performs a high-order ΣΔ modulation on the transmission signal and, converts the modulated signal into a low-voltage differential signal and outputs the converted signal to the analog front-end circuit; and the analog front-end circuit accumulates the low-voltage differential signal and down-samples it, then performs digital-to-analog conversion thereon and outputs the converted signal to the radio unit.

According to this embodiment, the number of signal lines between the baseband circuit and the radio unit can be reduced, thereby reducing the size of a terminal.

In this radio apparatus, the analog front-end circuit may convert a received signal output from the radio unit into a digital signal and up-sample and interpolate the digital signal, then may perform a high-order ΣΔ modulation on the signal, convert the modulated signal into a low-voltage differential signal and output the converted signal to the baseband circuit.

A radio apparatus may transmit and receive a signal modulated by W-CDMA (Wideband Code Division Multiple Access) scheme.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a block diagram showing a structure of a radio apparatus according to an embodiment of the present invention;

FIG. 2 is a block diagram showing internal structures of an analog front-end circuit and a baseband circuit shown in FIG. 1; and

FIGS. 3A to 3E are signal waveform diagrams of an analog front-end circuit and a baseband circuit shown in FIG. 2.

### DETAILED DESCRIPTION OF THE INVENTION

The invention will now be described by reference to the preferred embodiments. This does not intend to limit the scope of the present invention, but to exemplify the invention. All of the features and the combinations thereof described in the embodiment are not necessarily essential to the invention.

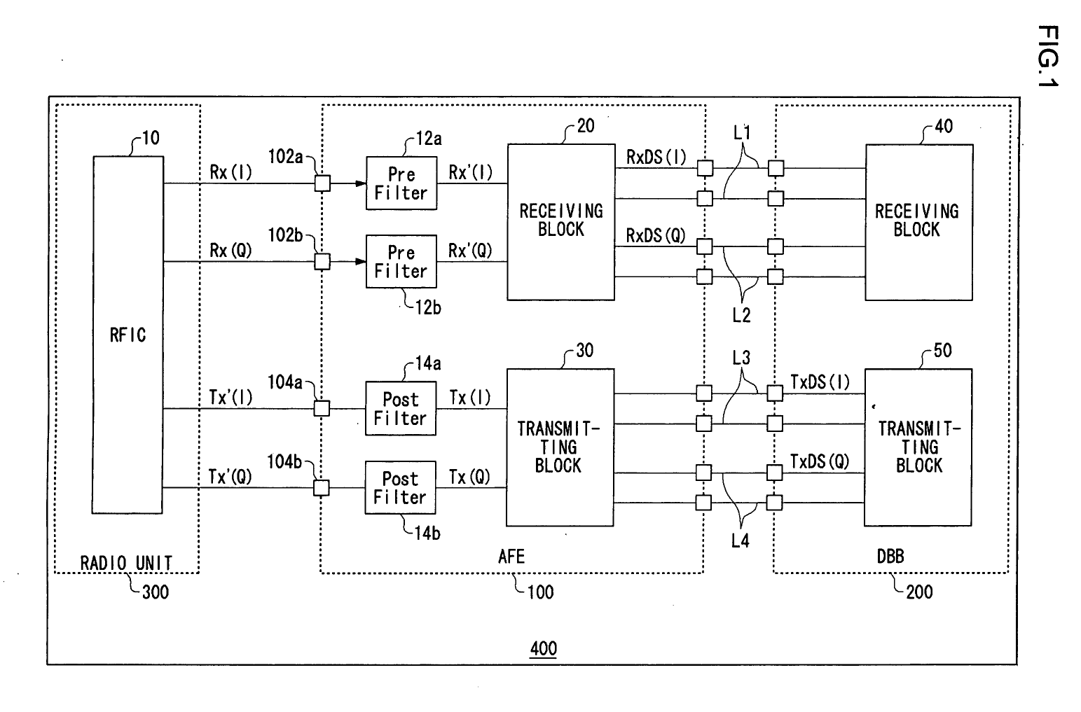

FIG. 1 is a block diagram showing a structure of a radio apparatus 400 according to an embodiment of the present invention. A description will be given of the present embodiment by assuming that the radio apparatus 400 is a mobile phone terminal of W-CDMA system.

The radio apparatus 400 includes an analog front-end circuit 100, a baseband circuit 200, and a radio unit 300. The analog front-end circuit 100, which is a circuit block for transmitting and receiving of data between the baseband circuit 200 and the radio unit 300, includes a receiving block 20, a transmitting block 30, pre-filters 12a and 12b, and post-filters 14a and 14b. The baseband circuit 200 also includes a receiving block 40 and a transmitting block 50. The receiving block 20 of the analog front-end circuit 100 and the receiving block 40 of the baseband circuit 200 perform the transmission and reception of data as a pair. The transmitting block 30 of the analog front-end circuit 100 and the transmitting block 50 of the baseband circuit 200 perform the transmission and reception of data as a pair.

Firstly, a description will be given of the flow of received signals and transmitting signals of the radio apparatus 400 according to the present embodiment.

The radio unit 300 includes an RFIC 10 and a not-shown amplifier, such as a power amplifier, and a not-shown antenna. The RFIC 10 amplifies the RF received signals received by the not-shown antenna and converts the frequency thereof into an intermediate frequency (hereinafter referred to as IF frequency) . The IF received signals converted into IF frequency signals are amplified by an AGC (Automatic Gain Control) amplifier and then divided into the I components and Q components by quadrature detection before they are output as received signals Rx(I) and Rx(Q). The received signals Rx(I) and Rx(Q) are respectively input to the input terminals 102a and 102b of the analog front-end circuit 100 and band-limited by the pre-filters 12a and 12b.

Although a detailed description will be given later, the receiving block 20 of the analog front-end circuit 100 converts received signals Rx′(I) and Rx′(Q) into bit stream signals by subjecting them to an analog-to-digital conversion and then a ΣΔ modulation. Then the receiving block 20 converts the bit stream signals into low-voltage differential signals RxDS (I) and RxDS (Q). The low-voltage differential signals RxDS(I) and RxDS(Q) are output to the baseband circuit 200 via differential signal lines L1 and L2.

The baseband circuit 200 performs a ΣΔ demodulation on the bit stream signals input as low-voltage differential signals RxDS (I) and RxDS (Q). Then data reproduction is carried out through despread by a demodulator inside.

The transmitting block 50 of the baseband circuit 200 performs a data modulation by a modulator inside, maps the I components and Q components, and outputs a spread chip data sequence. This chip data sequence is first converted into bit stream signals by a ΣΔ modulation and then into low-voltage differential signals TxDS(I) and TXDS(Q) before they are transmitted to the analog front-end circuit 100 via differential signal lines L3 and L4. The transmitting block 30 of the analog front-end circuit 100 performs a ΣΔ demodulation on the bit stream signals input as low-voltage differential signals TXDS(I) and TXDS(Q) and then subjects them to a digital-to-analog conversion before outputting them to the radio unit 300 as transmission signals Tx(I) and Tx(Q).

The transmission signals Tx(I) and Tx(Q) having undergone a digital-to-analog conversion are respectively band-limited at an analog filter (not shown) and the post-filters 14a and 14b and then output to the RFIC 10 as Tx′(I) and Tx′(Q).

The RFIC 10 performs a quadrature modulation on the transmitting signals Tx′(I) and Tx′(Q) by IF frequencies and then converts them into RF signals in a 2 GHz band. The RF signals are amplified by a power amplifier (not shown) in a subsequent position before being transmitted as radio waves from the antenna.

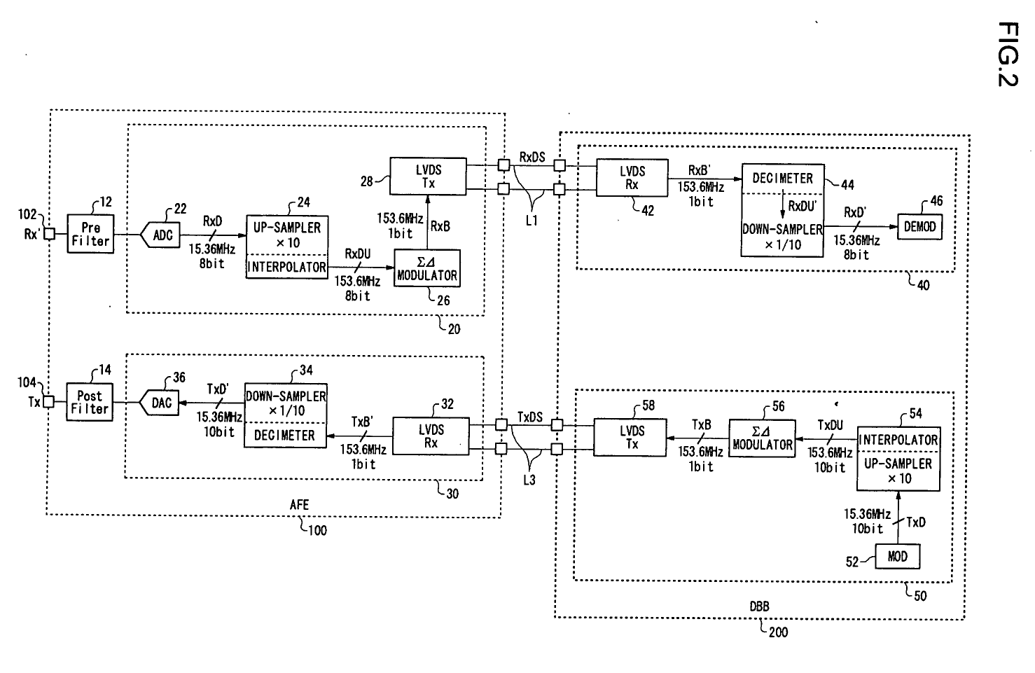

Now, internal structures of an analog front-end circuit 100 and a baseband circuit 200 are described in detail. FIG. 2 is a block diagram showing the internal structures of an analog front-end circuit 100 and a baseband circuit 200 as shown in FIG. 1. Although FIG. 2 shows only one of the I component and the Q component for easier viewing, both the I component and Q component are processed by an actual circuit. For further simplicity, note that the reference letters (I) and (Q) attached to the signals to distinguish between the I component and the Q component are omitted.

As aforementioned, the analog front-end circuit 100 is divided into a receiving block 20 and a transmitting block 30, whereas the baseband circuit 200 is divided into a receiving block 40 and a transmitting block 50. Firstly, a description is given of a structure of the receiving block 20 of the analog front-end circuit 100 and that of the receiving block 40 of the baseband circuit 200.

The receiving block 20 of the analog front-end circuit 100 includes an analog-to-digital converter 22, an interpolator 24, a ΣΔ modulator 26, and a low-voltage differential signal transmitter (hereinafter referred to as an LVDS transmitter) 28.

The analog-to-digital converter 22 performs an analog-to-digital conversion on analog received signals Rx′, which have been output from the radio unit 300 and input to the input terminal 102, at a resolution of m=8 bits and a reference sampling rate of fs=15.36 MHz.

The interpolator 24, which is a so-called interpolation filter, carries out a data interpolation by up-sampling the digital signals RxD output from the analog-to-digital converter 22 at a frequency of 10 times the reference sampling rate fs. Output from the interpolator 24 are digital signals RxDU of a sampling rate of fs′=153.6 MHz and a resolution of 8 bits.

The ΣΔ modulator 26 performs a ΣΔ modulation of a high order (fourth or higher) on the digital signals RxDU output from the interpolator 24. In the present embodiment, the ΣΔ modulator 26 is a fourth order ΣΔ modulator. From the viewpoint of signal accuracy, the lower limit of the order of the ΣΔ modulator 26 is preferably third or above. Also, the upper limit of the order of the ΣΔ modulator 26, which is restricted mainly by the circuit area, is preferably fifth or below. The order of the ΣΔ modulator 26 may be selected as appropriate between the third and the fifth order in consideration of the up-sampling rate fs′/fs and the desired accuracy of signals.

Output from the ΣΔ modulator 26 are bit stream signals RxB having undergone a ΣΔ modulation of 1 bit and 153.6 MHz. These bit stream signals RxB are input to the LVDS transmitter 28. The LVDS transmitter 28 converts the bit stream signals RxB into low-voltage differential signals RxDS and then transmits them to the baseband circuit 200 via the differential signal line L1.

Next, a structure of the receiving block 40 of the baseband circuit 200 is described. The receiving block 40 of the baseband circuit 200 includes a low-voltage differential signal receiver (hereinafter referred to as a LVDS receiver) 42, a decimation circuit 44, and a demodulator 46.

The LVDS receiver 42 receives low-voltage differential signals RxDS of 1 bit after a ΣΔ modulation, which are output from the analog front-end circuit 100, via the differential signal line L1 and converts them into bit stream signals RxB′.

The decimation circuit 44, which is a so-called decimation filter, accumulates the bit stream signals RxB′ output from the LVDS receiver 42 and performs a down-sampling to the reference sampling rate of fs=15.36 MHz. The output signals RxD′ of the decimation circuit 44 are digital signals of 8 bits and 15.36 MHz. The demodulator 46 demodulates the output signals RxD′ of the decimation circuit 44, using a predetermined scheme.

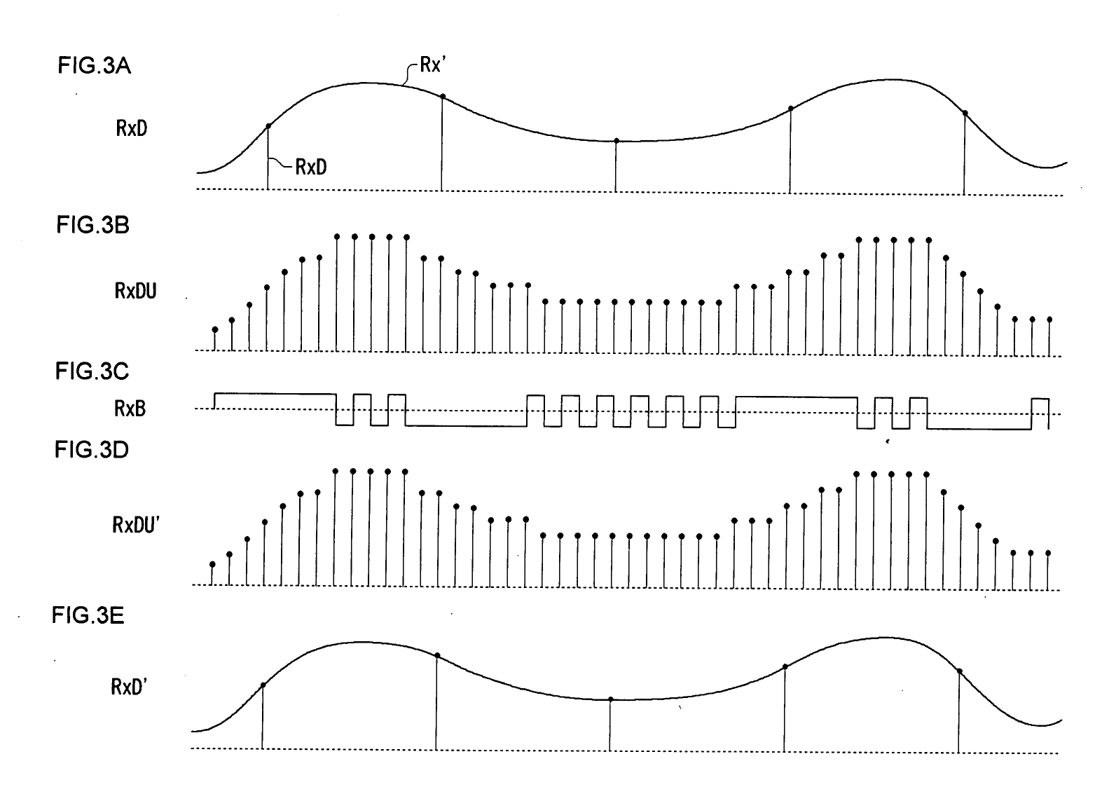

A description will now be given of an operation of the receiving block 20 of the analog front-end circuit structured as above and the receiving block 40 of the baseband circuit 200 structured as above. FIGS. 3A to 3E are the signal waveform diagrams of an analog front-end circuit 100 and a baseband circuit 200 as shown in FIG. 2. FIG. 3A shows analog received signals Rx′, and output signals RxD of the analog-to-digital converter 22. FIG. 3B shows output signals RxDU of the interpolator 24. FIG. 3C shows bit stream signals RxB output from the ΣΔ modulator 26. FIG. 3D shows signals RxDU having been ΣΔ-demodulated by the decimation circuit 44. FIG. 3E shows output signals RxD′ of the decimation circuit 44.

As shown in FIG. 3A, digital received signals RxD of 8 bits are generated as analog received signals Rx′ are analog-to-digital-converted by the analog-to-digital converter 22 at a reference sampling rate fs. These digital received signals RxD are input to a subsequent interpolator 24, where they are up-sampled and interpolated as shown in FIG. 3B. The output signals RxDU of the interpolator 24 are converted into bit stream signals RxB, as shown in FIG. 3C, by the ΣΔ modulator 26. The bit stream signals RxB are once converted into low-voltage differential signals RxDS at the LVDS transmitter 28 of the analog front-end circuit 100 before they are transmitted to the baseband circuit 200.

The low-voltage differential signals RxDS are converted into bit stream signals RxB by the LVDS receiver 42 of the baseband circuit 200 and then input to the decimation circuit 44. The decimation circuit 44 accumulates the bit stream signals RxB as shown in FIG. 3C, coverts them into the digital received signals RxDU′ as shown in FIG. 3D, and further generates the digital received signals RxD′ as shown in FIG. 3E by down-sampling before outputting them to the demodulator 46.

As described above, in a radio apparatus 400 according to the present embodiment, received signals received by the radio unit 300 are converted into digital signals of 1 bit after a high-order ΣΔ modulation before they are transmitted to the baseband circuit. As a result, the number of signal lines connecting the analog front-end circuit 100, the baseband circuit 200, and the radio unit 300 with one another can be reduced.

Furthermore, the data converted into bit stream signals by a ΣΔ modulation can be demodulated through a sequential accumulation processing at the baseband circuit 200, so that there is no need for exact synchronization between the analog front-end circuit 100 and the baseband circuit 200. This contributes to a simplification of the circuit.

Now, referring back to FIG. 2, a description is given of a structure of the transmitting block 50 of the baseband circuit 200 and that of the transmitting block 30 of the analog front-end circuit 100.

The transmitting block 50 of the baseband circuit 200 includes a modulator 52, an interpolator 54, a EA modulator 56, and a LVDS transmitter 58.

The modulator 52 outputs digital transmitting signals TxD, which have been data-modulated by a predetermined scheme, at a resolution of 10 bits and a reference sampling rate of fs=15.36 MHz. The digital transmitting signals TxD output from the modulator 52 are input to the interpolator 54.

The interpolator 54 converts the digital transmitting signals TxD into digital transmitting signals TxDU of 153.6 MHz and 10 bits by performing an up-sampling and interpolation. The ΣΔ modulator 56 performs a ΣΔ modulation on the digital transmitting signals TxDU output from the interpolator 54 and thereby converts them into bit stream signals TxB. The order of the ΣΔ modulator 56 is preferably third or above in the same way as with the ΣΔ modulator 26 of the analog front-end circuit 100. In the present embodiment, it is designed to be fourth order.

The LVDS transmitter 58 converts the bit stream signals TxB output from the ΣΔ modulator 56 into low-voltage differential signals TxDS and outputs them to the analog front-end circuit 100 via the differential signal line L3.

Next, a structure of the transmitting block 30 of the analog front-end circuit 100 is described. The transmitting block 30 of the analog front-end circuit 100 includes an LVDS receiver 32, a decimation circuit 34 and a digital-to-analog converter 36.

The LVDS receiver 32 receives low-voltage differential signals TxDS output from the baseband circuit 200 and converts them into bit stream signals TxB′. The decimation circuit 34 accumulates the bit stream signals TxB′ received by the LVDS receiver 32 and performs a down-sampling. The output signals TxD′ of the decimation circuit 34 are digital signals of 8 bits and 15.36 MHz.

The digital-to-analog converter 36 performs a digital-to-analog conversion on the output signals TxD′ of the decimation circuit 34 and outputs the analog transmitting signals Tx from the output terminal 104 to the radio unit 300.

Similarly to the case with the previously described receiving block 20 and receiving block 40, for the transmitting block 50 of the baseband circuit 200 and the transmitting block 30 of the analog front-end circuit 100 structured as described above, digital transmitting signals TxD generated by the baseband circuit 200 are converted into digital signals of 1 bit after a high-order ΣΔ modulation before they are transmitted to the analog front-end circuit 100. As a result, the number of signal lines connecting the analog front-end circuit 100, the baseband circuit 200 and the radio unit 300 with one another can be reduced. Furthermore, there is no need for exact synchronization between the analog front-end circuit 100 and the baseband circuit 200, which contributes to a simplification of the circuit.

The analog front-end circuit 100 according to the present embodiment is structured by a circuit block that can be easily realized by the use of a normal silicon process, which may comprise an analog-to-digital converter 22, a digital-to-analog converter 36, a ΣΔ modulator 26, an interpolator 24, and a decimation circuit 34. Accordingly, circuit integration is easy and circuit area can be reduced. Moreover, the high-order ΣΔ modulation does not require high-speed analog-to-digital conversion or digital-to-analog conversion. As a result, such a circuit block, which can be realized by a silicon process, is of low cost compared with ones made by a silicon-germanium process or the like.

The above-described embodiments are merely exemplary, and it is understood by those skilled in the art that various modifications to the combination of each component and process thereof are possible and such modifications are also within the scope of the present invention.

According to the present embodiment, an over-sampling at a frequency of 10 times the reference sampling rate fs is done at the receiving block of the analog front-end circuit 100 and the transmitting block 50 of the baseband circuit 200. The arrangement is not limited thereto, and an over-sampling at frequencies other than that may be made. The frequency for over-sampling and the order of the ΣΔ modulator may be so selected as to realize a desired accuracy.

In the present embodiment, a description has been given of a radio apparatus 400 of W-CDMA system. However, the present invention is also valid for CDMA2000 communication systems or fourth-generation communication systems as well as for radio apparatuses other than mobile phones.

While the preferred embodiments of the present invention have been described using specific terms, such description is for illustrative purposes only, and it is to be understood that changes and variations may be further made without departing from the spirit or scope of the appended claims.

What is claimed is:

1. An analog front-end circuit for transmitting and receiving data between a baseband circuit and a radio unit, the circuit comprising:
an analog-to-digital converter which converts an analog received signal output from the radio unit into a digital signal;
an interpolator which interpolates an output signal of said analog-to-digital converter by up-sampling the output thereof;
a high-order ΣΔ modulator which ΣΔ modulates an output signal of said interpolator; and
a low-voltage differential signal transmitter which converts an output signal of said ΣΔ modulator into a low-voltage differential signal and which transmits the converted signal to the baseband circuit via differential signal lines.

2. An analog front-end circuit according to claim 1, further comprising:
a low-voltage differential signal receiver which receives, via differential signal lines, a 1-bit transmission signal which is high-order ΣΔ modulated and output from the baseband circuit;
a decimation circuit which accumulates the 1-bit transmission signal received by said difference signal receiver and performs down-sampling thereon; and
a digital-to-analog converter which converts an output signal of said decimation circuit into an analog signal and outputs the converted signal to the radio unit.

3. An analog front-end circuit according to claim 1, wherein said circuit is integrated integrally on a single semiconductor substrate by a CMOS process.

4. An analog front-end circuit according to claim 2, wherein said circuit is integrated integrally on a single semiconductor substrate by a CMOS process.

5. An analog front-end circuit according to claim 3, wherein the semiconductor substrate is a silicon substrate.

6. An analog front-end circuit according to claim 1, wherein said interpolator up-samples by a factor of ten and the order of said ΣΔ modulator is fourth.

7. An analog front-end circuit according to claim 2, wherein said interpolator up-samples by a factor of ten and the order of said ΣΔ modulator is fourth.

8. A baseband circuit connected with a radio unit via an analog front-end circuit, the circuit comprising:
a modulator which outputs a transmission signal modulated by a predetermined scheme;
an interpolator which performs interpolation by up-sampling the transmission signal output from said modulator;
a high-order ΣΔ modulator which ΣΔ modulates an output signal of said interpolator; and
a low-voltage differential signal transmitter which converts an output signal of said ΣΔ modulator into a low-voltage differential signal and which transmits the converted signal to the analog front-end circuit via differential signal lines.

9. A baseband circuit according to claim 8, further comprising:
a low-voltage differential signal receiver which receives, via differential signal lines, a 1-bit received signal which is high-order ΣΔ modulated and output from the analog front-end circuit;
a decimation circuit which accumulates the 1-bit received signal received by said difference signal receiver and performs down-sampling thereon; and
a demodulator which demodulates an output signal of said decimation circuit by a predetermined scheme.

10. A radio apparatus, comprising:
a baseband circuit;
a radio unit; and
an analog front-end circuit which connects said baseband circuit with said radio unit with a low-voltage differential signal,
wherein said baseband circuit up-samples and interpolates a transmission signal to be output to the radio unit, then performs a high-order ΣΔ modulation on the transmission signal, converts the modulated signal into a low-voltage differential signal and outputs the converted signal to said analog front-end circuit, and
wherein said analog front-end circuit accumulates the low-voltage differential signal and down-samples it, then performs digital-to-analog conversion thereon and outputs the converted signal to said radio unit.

11. A radio apparatus according to claim 10, wherein said analog front-end circuit converts a received signal output from said radio unit into a digital signal and up-samples and interpolates the digital signal, then performs a high-order ΣΔ modulation on the signal, converts the modulated signal into a low-voltage differential signal and outputs the converted signal to said baseband circuit.

12. A radio apparatus according to claim 10, wherein said apparatus transmits and receives a signal modulated by W-CDMA (Wideband Code Division Multiple Access) scheme.

13. A radio apparatus according to claim 11, wherein said apparatus transmits and receives a signal modulated by W-CDMA (Wideband Code Division Multiple Access) scheme.
